(19) United States
(12) Patent Application Publication
(10) Pub. No.: US 2025/0123215 A1
(43) Pub. Date: Apr. 17, 2025

(54) Powder Storage Device Comprising An Enclosure, And Associated Method

(71) Applicants: L'AIR LIQUIDE SOCIÉTÉ ANONYME POUR L'ETUDE ET L'EXPLOITATION DES PROCÉDÉS GEORGES CLAUDE, Paris (FR); AddUp, Cébazat (FR)

(72) Inventors: Stéphane Dudret, Jouy En Josas (FR); Coralie Charpentier, Saint Priest (FR); Sébastien Doublet, Bagneux (FR); Edouard Chauvet, Saint-Pierre Du Perray (FR); Kilian Bounouar, Saint-Pierre Du Perray (FR)

(73) Assignees: L'AIR LIQUIDE SOCIÉTÉ ANONYME POUR L'ETUDE ET L'EXPLOITATION DES PROCÉDÉS GEORGES CLAUDE, Paris (FR); AddUp, Cébazat (FR)

(21) Appl. No.: 18/687,998

(22) PCT Filed: Sep. 1, 2022
(86) PCT No.: PCT/FR2022/051652

§ 371 Date: Feb. 29, 2024

(30) Foreign Application Priority Data
Sep. 1, 2021 (FR) FR2109149

(51) Int. Cl. G01N 21/81; B22F 12/00; B33Y 40/00; G01N 21/03

(52) U.S. Cl. CPC G01N 21/81; B22F 12/38; G01N 21/03; B33Y 40/00; G01N 2021/0339

(57) ABSTRACT

A powder storage device includes an enclosure configured to contain a powder and an atmosphere, the device having at least one sensitive element arranged inside the enclosure, such that at least one optical property of the sensitive element depends on the atmosphere inside the enclosure, the device having observation means including at least one observation part, which is at least partially transparent, the observation means making it possible to observe the optical property of the sensitive element from outside of the enclosure.

### FIELD OF THE INVENTION

The present innovation relates to the field of observation of the quality of the internal atmosphere of a reservoir containing a stock of powder, for example powder intended to be used in an additive manufacturing method.

The present innovation relates in particular to a powder storage device, a system and a method associated thereto.

### STATE OF THE ART

Powder storage devices are known. The powder can be stored for various applications, such as additive manufacturing or compaction and sintering manufacturing. The powder may need to be preserved under specific conditions to retain its properties. Moreover, the qualities of the powder may be uncertain for various reasons. The powder may be or comprise a recycled powder that is to say that has already been used, for example in an additive manufacturing process.

Furthermore, some properties of the powder may be unknown. The powder may be reactive, for example capable of self-ignition, for example in contact with an oxidant such as oxygen, for example gaseous oxygen, for example atmospheric oxygen. Alternatively or additionally, the powder may have been passivated, for example by the formation of a surface oxide layer, for example by voluntary or involuntary exposure to an oxidant. The actual or potential reactivity of the powders combined with their large specific surface, that is to say the ratio between the exchange surface of the powder grains and their volume, introduces a risk of explosiveness in their handling and use. Some powders may still pose a health risk, for example due to their carcinogenic or carcinogen nature.

Methods for directly monitoring the quality of a powder stored in an enclosure of a storage reservoir are known.

Some methods rely on a sampling of powder to extract it from the enclosure. In addition to the fact that these methods consume powder, the mechanism for extracting and collecting the powder is complex to implement. Such a mechanism is both a source of significant costs and of risks of contamination, in particular of the internal atmosphere of the enclosure by the external atmosphere. Moreover, during this type of sampling, the powder may be exposed to the atmosphere outside the enclosure, which may distort the results of the analysis.

Some methods use sensors placed within the mass of stored powder. On the one hand, they present a potential safety risk related to the introduction of energy within the powder, and on the other hand they are limited by the sensitivity and accuracy of the in situ sensors. Depending on the energies used, such sensors must be powered by an electrical network, thus limiting the mobility of the powder storage reservoirs.

It is therefore important, depending on the use for which it is intended, that a powder, particularly a powder intended to be mixed or resulting from a mixture, retains some properties. To do so, the powder should for example be stored under some conditions, for example an inert, dry and/or low-oxygen atmosphere. Checking the quality of the inert atmosphere preserving the powder is an indirect way of inferring the quality of the stored powder.

Methods for indirectly estimating the quality of a powder by the monitoring of its storage atmosphere are known.

Some methods are based on a sampling of atmosphere for a remote analysis. They require the set-up of an extractive and analysis line which, in addition to its cost which is all the higher that the atmosphere is potentially explosive, immobilizes the powder storage reservoir.

Some methods are based on the placement of active sensors within the atmosphere to be monitored. Depending on the technologies used, this approach can be accompanied by various drawbacks. It may need energy requirements such that a simple battery operation cannot be envisaged, or that a battery operation requires large batteries, resulting in problems of compactness, and therefore problems of mobility of the powder reservoirs and ergonomics problems. It may require the introduction of energy or energy sources on a prolonged or even permanent basis within a potentially explosive atmosphere. In addition to the electrical energy, significant heat can be released by the purging of hygrometric probes or by some oxygen content measuring cells. It can involve significant costs, in particular for the sensors and the associated drive electronics. Such methods are for example implemented by the company Carpenter Additive in its PowderEye active electronic module dedicated to monitoring the metal powder storage reservoir atmosphere for the additive manufacturing.

### DISCLOSURE OF THE INVENTION

One aim of the invention is to solve at least one of these drawbacks. One aim of the invention is particularly to provide a means for evaluating the quality of the powder contained in an enclosure involving a reduced cost. Another aim of the invention is particularly to provide a means for robust and/or secure monitoring of the quality of the powder contained in an enclosure. Another aim of the invention is particularly to provide an ergonomic means for monitoring the quality of the powder contained in an enclosure.

For this purpose, a powder storage device comprising an enclosure adapted to contain a powder and an atmosphere is proposed, the device comprising at least one sensitive element disposed inside the enclosure, so that at least one optical property of the sensitive element depends on the atmosphere inside the enclosure, the device comprising observation means comprising at least one at least partially transparent observation portion, the observation means making it possible to observe the optical property of the sensitive element from outside the enclosure.

The device can comprise the following characteristics, taken alone or in any one of their technically possible combinations:
the optical property of one at least of the at least one sensitive element depends on the humidity and/or on the oxygen content of the atmosphere inside the enclosure;
the optical property of one at least of the at least one sensitive element depends on the humidity of the atmosphere inside the enclosure, and the optical property of at least another of the at least one sensitive element depends on the oxygen content of the atmosphere inside the enclosure;
the observation means further comprise at least one at least partially reflective reflection element;
a bearing element of the sensitive element, against which the sensitive element is disposed, so that the sensitive element is disposed at a distance from the observation portion;
an elastic element arranged to hold one at least of the at least one sensitive element on the bearing element, the elastic element for example bearing against the observation portion or against the reflection element;
one at least of the at least one sensitive element is disposed against the observation portion;
a reference element, so that an optical property of the reference element does not depend on the atmosphere inside the enclosure, the optical property of the reference element having a value that the optical property of the sensitive element can take based on the atmosphere inside the enclosure, the reference element being for example disposed inside the enclosure;
means for filtering particles suspended in the atmosphere inside the enclosure, arranged to limit or avoid the deposition of the particles in suspension on the sensitive element and/or on the observation portion and/or on the reflection element.

A system comprising such a device and measuring means disposed outside the enclosure are further proposed, the measuring means being configured to measure the optical property of the sensitive element via the observation portion.

The system can comprise the following characteristics, taken alone or in any one of their technically possible combinations:
the system is an additive manufacturing or a compaction and sintering manufacturing system;
the system comprises a powder dosing and/or mixing sub-assembly.

A method for storing a powder inside the enclosure of such a device or such a system is further proposed, the method comprising a step of loading and/or extracting the powder inside the enclosure.

The method can further comprise a step of correctively modifying the atmosphere inside the enclosure, depending on the optical property of the sensitive element.

Such a device or such a system or such a method is further proposed, in which the powder storage device is a storage device intended for additive manufacturing, the device being adapted to preserve the stored powder with a view to using the stored powder in an additive manufacturing method.

The device or method or system can comprise the following characteristics, taken alone or in any one of their technically possible combinations:
the system is an additive manufacturing system using stored powder;
the stored powder is a metal powder, for example a micrometer grain metal powder.

### DESCRIPTION OF THE FIGURES

Other characteristics, aims and advantages of the invention will emerge from the following description, which is purely illustrative and not limiting, and which should be read in relation to the appended drawings in which:

FIG. 1 schematically illustrates a device according to one exemplary embodiment of the invention.

FIG. 2 schematically illustrates a device according to another exemplary embodiment of the invention.

FIG. 3 schematically illustrates an at least partially transparent portion of a device according to one exemplary embodiment of the invention.

FIG. 4 schematically illustrates a sensitive element of a device according to one exemplary embodiment of the invention.

FIG. 5 schematically illustrates another sensitive element of a device according to one exemplary embodiment of the invention.

FIG. 6 schematically illustrates yet another sensitive element according to one exemplary embodiment of the invention.

FIG. 7 schematically illustrates again a reference element and a sensitive element according to one exemplary embodiment of the invention.

FIG. 8 schematically illustrates observation means comprising a reflection element according to one exemplary embodiment of the invention.

FIG. 9 schematically illustrates other observation means comprising a reflection element according to one exemplary embodiment of the invention.

FIG. 10 schematically illustrates means for concealing observation means according to one exemplary embodiment of the invention.

FIG. 11 schematically illustrates other means for concealing observation means according to one exemplary embodiment of the invention.

FIG. 12 schematically illustrates a device according to another exemplary embodiment of the invention.

FIG. 13 schematically illustrates a device according to another exemplary embodiment of the invention.

FIG. 14 is a top view of a device according to another exemplary embodiment of the invention.

FIG. 15 is a side view of the device of FIG. 14.

FIG. 16 is a top view of a window of the observation means of the device of FIG. 14.

FIG. 17 schematically illustrates a system according to one exemplary embodiment of the invention.

FIG. 18A is a flowchart of steps of a method according to one exemplary embodiment of the invention.

FIG. 18B is a flowchart of steps of a method according to another exemplary embodiment of the invention.

In all the figures, similar elements bear identical references.

### DETAILED DESCRIPTION OF THE INVENTION

### General Description

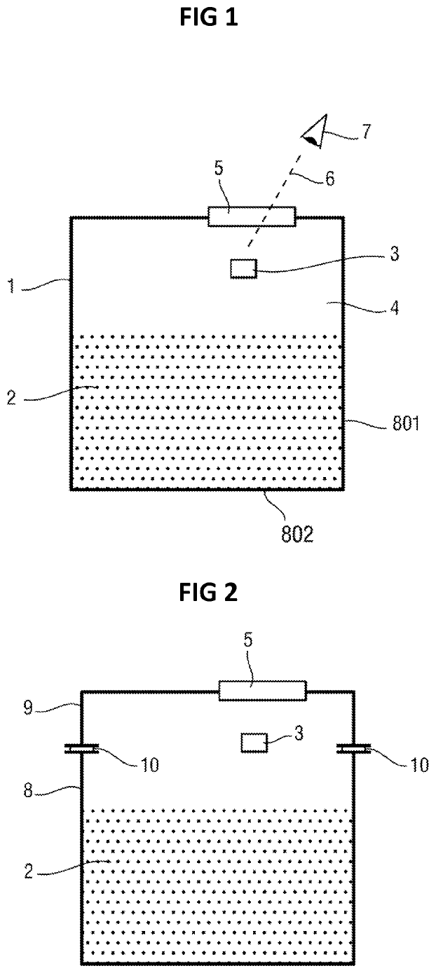

With reference to FIGS. 1 to 16, a powder storage device is described. The powder storage device can be a powder storage device intended to be used in an additive manufacturing method or in a compaction and sintering manufacturing method. The device comprises an enclosure 1 adapted to contain a powder 2, for example and an atmosphere 4. The device comprises at least one sensitive element 3 disposed inside the enclosure, so that at least one optical property of the sensitive element 3 depends on the atmosphere inside the enclosure. The device comprises observation means comprising at least one at least partially transparent observation portion 5, the observation means making it possible to observe the optical property of the sensitive element from outside the enclosure.

It is thus possible to effectively carry out an observation, for example an evaluation, for example a measurement, of the quality of the internal atmosphere of the enclosure, for example adapted to receive a stock of powder. It is thus possible to indirectly evaluate the quality of an element stored in the enclosure, for example stored powder.

Such a device has an advantage in terms of cost. Indeed, it makes it possible to implement unit cost indicators reduced compared to the cost of a sensor having the same function and integrated into the device to measure the powder or the atmosphere inside the enclosure, or to a measuring system involving the powder or atmosphere extraction. Such a device can be implemented without integrating a bulky battery that must be recharged or a bulky additional electrical installation, thereby limiting the maintenance costs and the ecological footprint.

Such a device also has the advantage of robustness. It does not require the use of a multitude of dedicated active components and therefore limits the sensitivity of the device portions associated with the measurement to disturbances such as radio frequencies.

Such a device also has an intrinsic safety advantage. The internal volume of the enclosure may present an explosive risk, in particular in the event of a lack of inerting, related to the presence of combustible particles suspended in the atmosphere. However, through the limitation of the active components inside the enclosure, and through the limitation in the quantity and occurrences of energy input into the powder storage enclosure, the device limits the risks of triggering an explosion. Furthermore, the device prevents the release of nanometer and micrometer particles towards the external environment, thus limiting health and explosiveness risks. Particularly, unlike a sampling of the atmosphere, with a pump for example, there is no risk of entraining particles that would already be in suspension. In addition, such a device makes it possible to limit the contact of the stored powder with oxidizing atmospheres thus limiting the risks of explosiveness and degradation of the metallurgical characteristics of the powder, and/or with humid atmospheres thus limiting the risks of reduced flowability. Particularly, unlike the introduction of a movable sampling member into the atmosphere of the enclosure, the risk of contamination of the interior atmosphere by the external atmosphere to be managed is limited. Such a device makes it possible to limit or reduce the exposure of the operators to powders, for example to metal powders. The device also makes it possible to limit the contact of the powders with energies that could cause their ignition. Particularly, unlike the introduction of a permanent probe into the enclosure, for example of the dew point sensor type for humidity, or zirconia oxygen sensor, which sensors emit strong heat, the significant energy input is avoided and the risk of directly igniting the suspended powder or indirectly degrading the powder bed is limited.

Such a device also has an ergonomic advantage. Indeed, the footprint on the device of such an arrangement, particularly on a reservoir of the device, for example on the enclosure, is reduced, compared for example to some devices combining inner sensors and drive and battery power supply box. The bulk of the device can thus be reduced accordingly and the device can for example be more easily transportable. It is thus possible to limit the bulk. It is particularly possible to avoid using certain very bulky sensors, such as sensors with the shape of very elongated cylinders. Such a device can also have greater ergonomics and/or ease of handling and/or manipulation. Particularly, by limiting the elements to be placed on the enclosure, it is easier to access the elements of the device such as valves, or to connect the device to a displacement means, such as the forks of a forklift which must be slipped under or through the device.

It is thus possible to preserve a quantity of powder, for example metal powder, for example intended for additive manufacturing, by preserving it in an optimal, for example inert atmosphere, for example with monitored pressure and/or oxygen content and/or humidity, allowing the verification of these quantities. The device can be a powder storage device intended for the additive manufacturing, the device being able be adapted to preserve the stored powder with a view to using the powder stored in an additive manufacturing method.

The device can comprise several sensitive elements 3 disposed inside the enclosure 1, so that, for each sensitive element 3, at least one optical property of the sensitive element 3 depends on the atmosphere inside the enclosure, for example depends on a quantity characteristic of the atmosphere inside the enclosure, for example so that among the optical properties depending on the atmosphere inside the enclosure, for at least two sensitive elements, the optical properties are different. Several of the sensitive elements 3 can for example be observed through the same observation portion 5, and/or the optical properties of several of the sensitive elements 3 can for example be observed through the same observation portion 5. The device can comprise observation means comprising several at least partially transparent observation portions 5, for example at least one, or each, for example the observation means making it possible to observe the optical properties of the sensitive elements from outside the enclosure 1, for example optical properties of distinct sensitive elements via distinct observation portions 5.

### System

With reference to FIG. 17, a system 70 is described comprising at least such a device, for example several such devices, for example such a first device 702A and/or such a second device 702B and/or such a third device 702C.

The system 70 can be an additive manufacturing or a compaction and sintering manufacturing system, for example a system for additive manufacturing from the stored powder, for example system for metal additive manufacturing for example with selective laser melting (laser beam melting).

The device(s) 702A and/or 702B and/or 702C can be adapted to mechanically cooperate with a dosing sub-assembly 701, for example weight dosing sub-assembly, and/or powder mixing sub-assembly, for example with continuous technology, for example with screw technology. The device or one or several of the devices is for example adapted to discharge into the dosing and/or mixing sub-assembly 701, powder to be mixed, and/or is for example adapted to collect the dosed and/or mixed powder derived from the dosing and/or mixing sub-assembly.

The system 70 can comprise an assembly 700 for mixing a first powder and a second powder. The mixing assembly 700 can be a continuous mixing assembly.

By “continuous”, it is meant for example that the device operates continuously with streams of powders, as opposed to a batch mixture where all of the powder is mixed at the same time.

The mixing assembly 700 can comprise the powder dosing and/or mixing sub-assembly 701. The sub-assembly 701 can comprise a first doser 703A for the first powder. The first doser 703A can be a continuous doser. The sub-assembly 701 can comprise a second doser 703B for the second powder.

The second doser 703B can be a continuous doser.

The sub-assembly 701 can comprise a mixer 704. The mixer 704 can be arranged to mix the first powder dosed by the first doser 703A and the second powder dosed by the second doser 703B, so as to provide a continuous stream of mixed powder. The stream can be provided according to a determined ratio, for example dependent on the first doser 703A and on the second doser 703B.

The sub-assembly 701 can comprise a sampler 705 adapted to take a fraction of the stream of mixed powder. The sampler 705 can comprise a sample container 706, for example a removable sample container. The sampler 705 can be adapted to discharge the or each quantity of powder taken into the container 706. It is thus possible to subsequently carry out analyzes of the characteristics of the taken powder.

The mixing assembly 700 makes it possible to produce a homogeneous mixture, that is to say without segregation, or with limited segregation, by density, by composition or by particle size in the final mixed product, of two powders, while meeting throughout the mixing operation a ratio of the proportions, for example mass proportions, of the powders mixed in the final product, by protecting them more easily from external atmosphere contamination, by more easily protecting the operators from exposure to the powders, by more easily preventing the risks related to the possible formation of an explosive atmosphere by the suspension of powder particles, and by allowing the traceability of the operation, in particular by the sampling of the powder mixed during its production.

The mixing assembly 700 can thus form a doser-mixer.

The mixing assembly 700 can be adapted to store the first powder and/or the second powder and/or the mixed powder. The device can further comprise the first device 702A for storing the first powder, the first device 702A forming a reservoir for the first powder, the first device 702A being arranged to store the first powder and/or to continuously provide the first powder to the first doser 703A, for example by gravity. The first device 702A can store the first powder. The first powder can be a new powder. The mixing assembly 700 can comprise the second device 702B for storing the second powder, the second device 702B forming a reservoir for the second powder, the second device 702B being arranged to store the second powder and/or to continuously provide the second powder to the second doser 703B, for example by gravity. The second device 702B can store the second powder. The second powder can be a recycled powder.

The mixing assembly 700 can comprise a third device 702C for storing the mixed powder, the third device 702C forming a reservoir for the mixed powder, the third device 702C being arranged to receive the stream of mixed powder. The third device 702C can be arranged to continuously receive, for example by gravity, the mixed powder derived from the mixer 704. The third device 702C can store mixed powder.

The system 70 can comprise measuring means 7 as described below, the measuring means 7 being common to the devices of the system 70.

The system 70 can comprise one or several manufacturing machine(s) 710. The manufacturing machine(s) 710 is/are for example one or several additive manufacturing or compaction and sintering manufacturing machine(s). The manufacturing machine(s) 710 may be or comprise one or several machine(s) using metal powder(s), for example one or several machine(s) with selective laser melting of metal powders.

The system 70 can comprise, for example upstream of the manufacturing machine 710, one or several powder sieve(s) (not represented). The mixing assembly 70 can comprise, for example downstream of the manufacturing machine 710 and/or upstream of at least one among the devices 702A and 702B, the or one of the powder sieve(s).

The transfer(s) of powder from or within the system 70 can be carried out by means of one or several powder conveying mean(s), for example one or several powder conveying unit(s), for example one or several powder conveyor(s) or by gravity.

The transfer(s) of powder within the system 70 can comprise the transfer from a stock of powder of the system 70 (not represented) and/or from the sieve (not represented) and/or from the manufacturing machine(s) 710, to one of the devices 702A and 702B. The transfer(s) of powder within the system 70 can comprise the transfer from the device 702C to the manufacturing machine(s) 710. The transfer(s) of powder within the system 70 can comprise the transfer from at least one of the devices 702A and 702B to the sub-assembly 701. The transfer(s) of powder within the system 70 can comprise the transfer from the sub-assembly 701 to the device 702C.

The device(s) 702A and/or 702B and/or 702C can be movable within the system 70 to allow the transport of powder within the system 70, particularly to allow transfers of powder by gravity. The device 702C is for example movable or moved between a first position below the sub-assembly 701, allowing the discharge of powder by gravity from the sub-assembly 701 to the device 702C, and a second position above the manufacturing machine(s) 710, allowing the discharge of powder by gravity from the device 702C to the manufacturing machine(s) 710. The device(s) 702A and/or 702B can be movable or moved between a first position below the powder storage (not represented), allowing the powder discharge by gravity from said powder storage (not represented) to the device(s) 702A and/or 702B, and a second position above the sub-assembly 701, allowing the discharge of powder by gravity from the device(s) 702A and/or 702B to the sub-assembly 701. The device(s) 702A and/or 702B and/or 702C can be movable or moved, for example by means of a forklift.

### Enclosure

The device can comprise a powder reservoir, for example the enclosure 1 forming the reservoir.

The enclosure 1 can comprise a body 8. The body 8 can comprise a side wall 801. The enclosure 1 can comprise a lower portion 802, comprising for example a bottom, for example adapted so that the powder 2 rests on it. The body can be adapted to receive the powder 2, for example receives the powder 2. The body 8 can comprise the lower portion 802, for example so that the side wall 801 and the lower portion 802 are formed in one piece or form two distinct portions fixed to each other, for example by mechanical cooperation, for example in a separable manner. The enclosure 1, for example the body 8, can comprise or be formed of a tank, for example a tank comprising a cylindrical portion and/or a conical portion, for example a cylindro-conical tank, for example in which the cylindrical portion is disposed above the conical portion, for example the cylindrical portion forming the side wall 801 and/or the conical portion forming the lower portion 802.

By “lower”, respectively “upper”, it is meant towards the bottom, respectively towards the top, in a laboratory reference frame when the device or the enclosure 1, or any element of the system, is in the position of use, and/or it is meant in the direction defined by gravity or on the side where the powder is stored, respectively in a direction opposite to gravity or opposite to the side where the powder 2 is stored. By “below”, respectively “above”, it is meant towards the bottom, respectively towards the top, in a laboratory reference frame when the device or the enclosure 1, or any element of the system, is in position of use, and/or it is meant in the direction defined by gravity or on the side where the powder is stored, respectively in a direction opposite to gravity or opposite to the side where the powder 2 is stored. The enclosure 1 can comprise an upper portion 9. The enclosure 1 may be in one piece or result from the mechanical cooperation of several separable parts. The upper portion 9 and the body 8 can be formed in one piece or form two distinct portions fixed to each other, for example by mechanical cooperation, for example in a separable manner. Thus, as illustrated in FIG. 2, the upper portion 9 can comprise a cover. The body 8 and the upper portion 9 can be connected, for example fixed, for example in a separable manner, to each other, in a sealed manner, for example by a sealed joint, for example by one or several seal(s) 10, the seal(s) being for example arranged to be crushed by the upper portion 9, for example by the cover.

The enclosure can comprise a wall of the enclosure, the wall of the enclosure being able to form the body 8, for example the side wall 801 and/or the lower portion 802 and/or the upper portion 9.

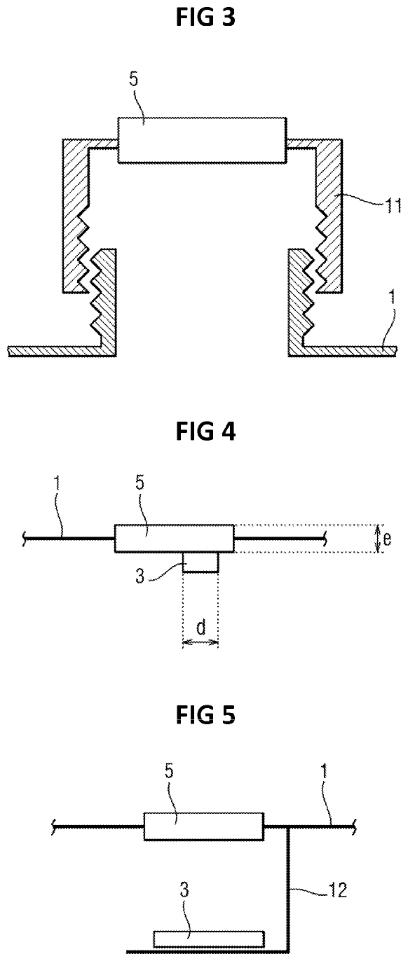

The body 8 or the upper portion 9 can be provided with, for example carry or receive the observation portion 5, for example the window as described below. The observation portion 5, for example the window, can be removably mounted on the rest of the enclosure, for example on the body 8 or the upper portion. The observation portion 5 is for example mounted on the upper portion 9, for example on the cover, for example on an upper face of the cover, for example oriented substantially upwards. As illustrated in FIG. 3, the observation portion 5 can be removably fixed to the rest of the enclosure 1, for example to the body 8 or to the upper portion 9, for example by means of a removable support 11 of the device, for example of the enclosure, to which the observation portion 5 is secured. The observation portion 5 can be removably fixed to the rest of the enclosure 1, for example to the body 8 or to the upper portion 9, for example by screwing, for example by means of a ferrule adapted to be screwed onto a complementary element of the enclosure 1, the ferrule comprising for example a thread, for example at the level of one face of the ferrule turned towards the inside of the ferrule, the complementary element comprising a complementary thread, for example at the level of one face of the complementary element turned towards the outside of the complementary element. The removable support 11 can comprise the ferrule.

The observation portion 5 can be slipped or crimped into the removable support 11. The observation portion 5, the removable support 11 and the complementary element of the enclosure correspond for example to the soldering window marketed under the reference 62426 by Bene Inox (registered trademark). Alternatively, the observation portion 5 can be directly crimped into the enclosure, for example in a non-removable manner, or the observation portion 5 can be mounted on a tilting cover.

Similarly, the body 8 or the upper portion 9 can be provided with, for example carry or receive the second observation portion 5′, for example the second window as described below. The second observation portion 5′, for example the second window, can be removably mounted on the rest of the enclosure, for example on the body 8 or the upper portion. The second observation portion 5′ is for example mounted on the upper portion 9, for example on the cover, for example on an upper portion of the cover, for example oriented substantially upwards. The second observation portion 5′ can be removably fixed to the rest of the enclosure 1, for example to the body 8 or to the upper portion 9, for example by means of a second removable support 11′ of the device, for example of the enclosure 1, to which the second observation portion 5′ is secured. The second observation portion 5′ can be removably fixed to the rest of the enclosure 1, for example to the body 8 or to the upper portion 9, for example by screwing, for example by means of a second ferrule adapted to be screwed onto a second complementary element of the enclosure 1, the second ferrule comprising for example a thread, for example at the level of a second face of the second ferrule turned towards the inside of the ferrule, the second complementary element comprising a complementary thread, for example at the level of a second face of the second complementary element turned towards the outside of the second complementary element. The second removable support 11′ can comprise the second ferrule.

The second observation portion 5′ can be slipped or crimped into the second removable support 11′. The second observation portion 5′, the second removable support 11′ and the second complementary element of the enclosure correspond for example to the soldering window marketed under the reference 62426 by Bene Inox (registered trademark). Alternatively, the second observation portion 5′ can be directly crimped into the enclosure 1, for example in a non-removable manner, or the second observation portion 5′ can be mounted on a tilting cover.

The enclosure 1 contains for example the powder 2. The atmosphere inside the enclosure 1 can be the atmosphere in which the powder 2 is immersed. The atmosphere inside the enclosure 1 designates the internal atmosphere, for example a volume of gas enclosed by the enclosure 1. The atmosphere inside the enclosure can constitute the internal atmosphere. The device, for example the enclosure 1, can delimit an internal volume, for example intended to accommodate the powder and to contain the internal atmosphere, in a sealed manner. The internal volume can for example be defined as the portion of universe to be inside the enclosure 1. By “atmosphere inside the enclosure”, it is meant for example the gaseous layer inside the enclosure, for example in the portion of the internal volume which is not occupied by the powder, the gaseous layer comprising a gas or a mixture of gases. The atmosphere inside the enclosure may have one or several parameter(s), for example humidity or oxygen content.

The internal volume of the enclosure 1 can be comprised between 10 and 100 L, for example between 20 and 50 L, for example between 35 and 45 L, for example of the order of 38 L. The maximum volume of stored powder 2 can be comprised between 8 and 80 L, for example between 16 and 40 L, for example between 28 and 34 L, for example of the order of 30 L.

The device can comprise means 37 for supporting the enclosure 1, for example one or several feet 37, for example each comprising a portion connected to the enclosure 1 and/or a removable extension 38. The enclosure 1 and/or the body 8 and/or the upper portion 9 may be opaque. The enclosure 1 and/or the body 8 and/or the upper portion 9 can comprise a metal material, for example opaque material.

### Connection and Bearing Element

As illustrated by FIGS. 5, 6 and 13, the sensitive element 3 can be connected, for example in a secured manner, to the body 8 and/or to the upper portion 9, for example by means of one or several connection part(s). The sensitive element 3 can be connected in a secured manner, for example fixed, to the body 8 and/or to the upper portion 9 so as not to fall into the powder 2 or slip out of a field of view permitted by the observation means. The sensitive element 3 can particularly be connected in a removable manner, so that it can be replaced if necessary.

The device can comprise a bearing element 12, for example a bearing part, of the sensitive element 3 or of one of the sensitive elements 3, against which the sensitive element 3 is disposed, so that the sensitive element 3 is disposed at a distance from the observation portion. It is thus possible to place the sensitive element 3 in an area where the atmosphere is better stirred and/or more quickly homogenized, for example in the event of gas reinjection or leak, so that the optical property observed is all the more reactive to modifications in the characteristics of the internal atmosphere and representative of the entire internal volume as much as possible. Moreover, it is thus possible to increase the exchange surface between the sensitive element 3 and the atmosphere inside the enclosure, for example so that the optical property can be observed over the largest surface of contact and exchange with the atmosphere. The sensitive element 3 can be disposed facing the observation portion 5 or a reflection element 16 as described below.

The bearing element 12 can be secured to the enclosure 1, for example to the body 8 and/or to the upper portion 9.

The bearing element 12 can comprise a connection section adapted to be mechanically fixed to the body 8 or to the upper portion 9, and/or a bearing section against which the sensitive element 3 is disposed. The connection section and the bearing section can for example be connected to each other in a secured manner, for example so as to form an angle, for example so as to give the bearing element an “L” shape.

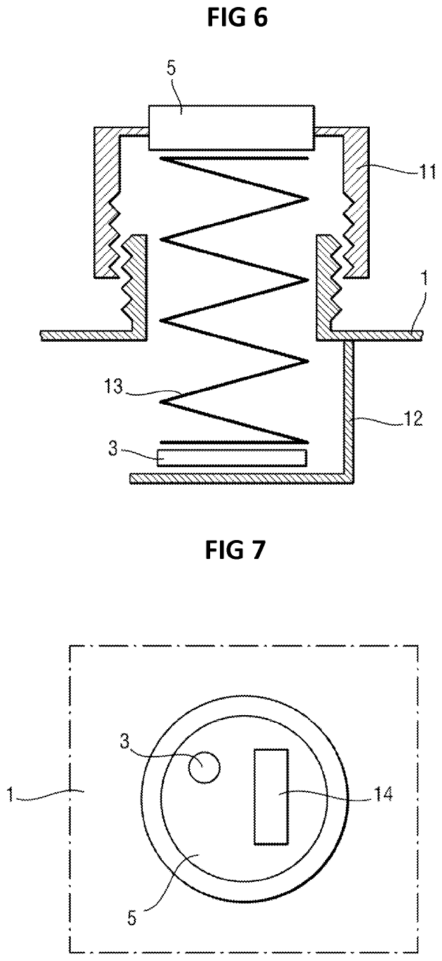

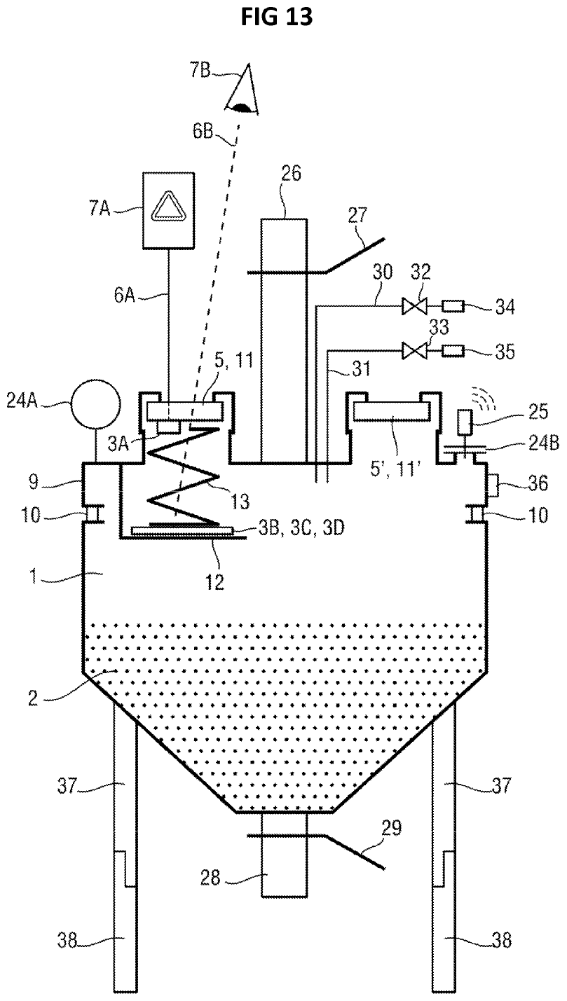

The device can comprise means for holding the sensitive element 3 on the bearing element 12. The holding means can comprise one or several element(s) secured to the bearing element 12, for example one or several corner piece(s), and/or one or several clamp(s), and/or one or several adhesive(s). The device, for example the holding means, for example the secured element(s), can further comprise an elastic element 13 arranged to hold the sensitive element 3 on the bearing element, the elastic element 13 bearing for example against the observation portion 5 or against the reflection element 16 as described below and/or the elastic element 13 bearing for example against the sensitive element 3, the sensitive element for example also bearing against the bearing element 12, as illustrated in FIGS. 6 and 13. This is particularly advantageous in the case where the observation portion 5 is removably fixed to the rest of the enclosure 1, for example to the body 8 or to the upper portion 9, for example by screwing. The elastic element 13 can be a spring, for example a compression spring. The fixing, for example the screwing of the observation portion 5, for example of the window, on the rest of the enclosure 1, for example on the body 8 or the upper portion 9, can ensure the compression of the spring and the holding of the sensitive element 3 against the bearing element 12. This configuration allows both the holding of the sensitive element 3 and an adapted fixing, for example tightening, of the observation portion 5 on the rest of the enclosure 1 to ensure the sealing. The use of such an elastic element 13 is particularly advantageous compared to that of a rigid wedge between the observation portion 5 and the sensitive element 3 to be pressed against the bearing element 12. Indeed, if the wedge is too long, for example due to manufacturing or expansion tolerances, there is a risk of not being able to screw the window to the maximum, and therefore of having poor sealing at this location. With the elastic element 13, it is possible to stop the tightening at the desired level while correctly pressing the sensitive element 3 on the bearing element 12, the elastic element compensating for the missing or excess length.

### Observation Means

At least partially transparent observation portion

The device, for example the observation means, can comprise a hole.

The hole can comprise a closed aperture, for example orifice, for example in a sealed manner. The aperture can be a through aperture made in the wall of the enclosure 1. The observation portion 5 can extend at least partially at the level of the aperture. The observation portion can participate in the sealed closing of the aperture. Alternatively, the observation portion 5 can be formed in one piece with the wall of the enclosure 1, for example so that the wall of the enclosure 1 is at least partially transparent over its entire thickness at the location of the observation portion 5.

The observation portion 5 can comprise a window. The observation portion 5 can for example comprise or be formed of glass, for example crystal glass, for example sapphire glass, for example Pyrex type glass (registered trademark). The observation portion 5 allows the observation of the interior of the enclosure and/or of the sensitive element 3, for example of the optical property of the sensitive element, directly or through one or several other portion(s) for example by means of one or several reflection element(s) as described below, for example by a measuring means 7 and/or by the eye of an individual, the individual being for example an operator and/or an observer. The observation from outside the enclosure 1 can follow an optical path passing through the observation portion 5, for example through the observation portion 5. The device allows the observation of the optical property of the sensitive element through the observation portion 5, for example through the window.

The footprint of the observation means, particularly of the observation portion 5, for example of the hole and/or the window, on the powder is reduced.

The observation portion 5 can comprise an inner face and/or an outer face. The inner face is for example between the sensitive element 3 and the outer face on the direct light path connecting the exterior of the enclosure 1 to the sensitive element and passing through the observation portion. The inner face can be turned towards the inside of the enclosure and/or in contact with the atmosphere inside the enclosure. The outer face can be turned towards the outside of the enclosure and/or in contact with the ambient atmosphere or outside the enclosure. The at least partially transparent observation portion 5 can be transparent or partially transparent, for example along an optical path between the inner face and the outer face, for example over its entire thickness.

The footprint can be all the more reduced as the observation portion 5, for example the hole and/or the window, for the visualization of the sensitive element 3, can also form an observation portion 5, for example a hole and/or a window, adapted to allow the observation, from outside the enclosure 1, of the powder 2 stored inside the enclosure 1. This additional possibility of visualization, for example direct visualization, of the powder, may be wanted for example for the purposes of monitoring the apparent flowability of the powder and the quality of the filling. Alternatively or additionally, a second powder observation portion can be provided as described below.

By “at least partially transparent portion”, it is meant for example having a transmittance ≥85% in the band(s) of optical wavelengths of interest, for example in the visible optical band extending from 400 to 800 nm.

### Second Observation Portion

The observation means can comprise a second at least partially transparent observation portion 5′ distinct from the first observation portion 5, adapted to allow the observation, from outside the enclosure 1, of the powder 2 stored inside the enclosure 1.

The device, for example the observation means, can comprise a second hole.

The second hole can comprise a second aperture, for example a second orifice, for example closed, for example in a sealed manner. The second aperture can be a through aperture made in the wall of the enclosure 1. The second observation portion 5′ can extend at least partially at the level of the second aperture. The second observation portion can participate in the sealed closing of the second aperture. Alternatively, the second observation portion 5′ can be formed in one piece with the wall of the enclosure 1, for example so that the wall of the enclosure 1 is at least partially transparent over its entire thickness at the location of the observation portion 5′.

The second observation portion 5′ can comprise a second window. The second observation portion 5′ can for example comprise or be formed of glass, for example crystal glass, for example sapphire glass, for example Pyrex type glass (registered trademark). The second observation portion 5′ allows the observation of the interior of the enclosure and/or of the powder 2, directly or through one or several other portion(s), for example by means of one or several reflection element(s) as described below, for example by a measuring means 7 and/or by the eye of the individual, for example of the operator and/or or the observer.

The second observation portion 5′ can comprise a second inner face and/or a second outer face. The second inner face is for example between the powder 2 and the second outer face on the direct light path connecting the exterior of the enclosure to the powder 2 and passing through the second observation portion. The second inner face can be turned towards the inside of the enclosure and/or in contact with the atmosphere inside the enclosure. The second outer face can be turned towards the outside of the enclosure and/or in contact with the ambient atmosphere or outside the enclosure. The second at least partially transparent observation portion 5′ can be transparent or partially transparent, for example along an optical path between the inner face and the outer face, for example over its entire thickness.

### Reflection Element

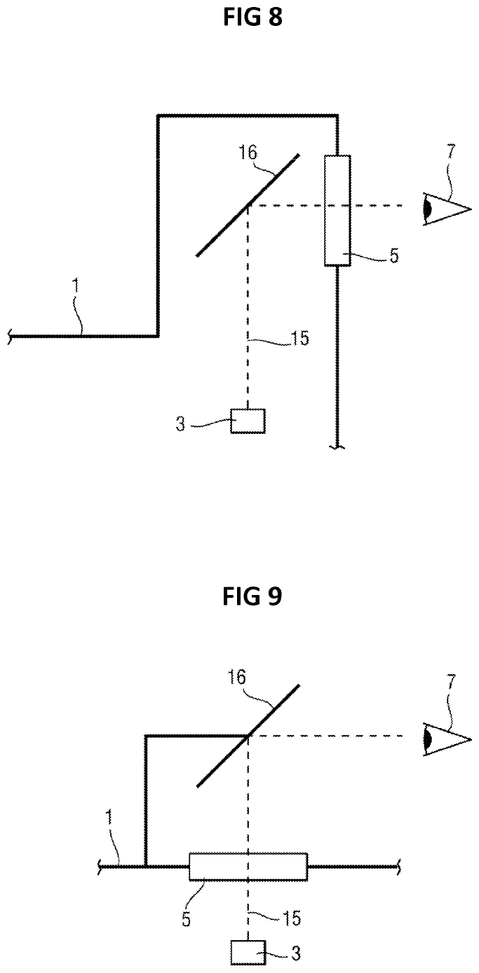

As illustrated in FIGS. 8 and 9, the observation means can further comprise at least one at least partially reflective reflection element 16, for example a reflector, for example a mirror, for example several such reflection elements 16. The reflection element(s) make(s) it possible to establish an indirect optical path 15, for the observation of the sensitive element 3, rather than a direct optical path not involving an intermediary upstream or downstream of the observation portion 5 from the sensitive element 3. At least one of the reflection element(s) 16 can be disposed inside the enclosure 1, as illustrated in FIG. 8, and thus be upstream of the observation portion from the sensitive element 3. Alternatively or additionally, at least one of the reflection element(s) 16 can be disposed outside the enclosure 1, as illustrated in FIG. 9, and thus be downstream of the observation portion from the sensitive element 3.

By “upstream from a given portion”, respectively “downstream from a given portion”, it is meant upstream, respectively downstream, relative to the direction of propagation of a stream of photons derived from the given portion considered as a source, for example from the sensitive element 3 or measuring means 7, that is to say relative to the optical path from the portion considered as a source.

The reflection element(s) 16 can be fixed to the enclosure 1.

Similarly, the device, for example the observation means, can further comprise at least one second at least partially reflective reflection element, for example a reflector, for example a mirror, for example several such second reflection elements. The second reflection element(s) make(s) it possible to establish an indirect optical path, for the observation of the powder 2, rather than a direct optical path not involving an intermediary upstream or downstream of the second observation portion 5′ from the powder 2. At least one of the second reflection element(s) can be disposed inside the enclosure 1 and thus be upstream of the second observation portion from the powder 2. Alternatively or additionally, at least one of the second reflection element(s) can be disposed outside the enclosure 1, and be thus downstream of the second observation portion from the powder 2. The second reflection element(s) can be fixed to the enclosure 1. The second reflection element can be distinct from the reflection element 16 for observing the sensitive element 3, or alternatively, the second reflection element can be formed by the reflection element 16 for observing the sensitive element 3, the optical paths coming from the observation portion 5 and from the observation portion 5′ passing through the same reflection element while following distinct trajectories.

### Sensitive Element

### General Description of the Sensitive Element

The sensitive element 3 can be a passive element. By “passive” it is meant an element that checks several conditions. The first condition is that the sensitive element 3 does not comprise an energy source internal to itself. The second condition is that the optical property can be measured, estimated or observed by an observation not requiring providing it with energy or that the energy supply necessary for an observation allowing the measurement, the estimation or the observation of the optical property is only carried out by means of an energy source external to the sensitive element 3 and external to the device, and without requiring mechanical cooperation or mechanical continuity between the sensitive element 3 and the energy source. A passive element can thus be powered without contact, for example by optical or radiofrequency stimulation. The third condition is that the operation of the sensitive element 3, that is to say the modification, maintenance and manifestation of the optical property, does not require a transfer of the energy received from the possible external energy source towards the internal atmosphere 4. For example, the sensitive element 3 does not return energy into the gas of the internal atmosphere to probe it, nor does it use the energy received to desorb from the adsorbed gas as a purging humidity probe would do it.

The fact that the sensitive element 3 is a passive element, for example allowing an observation solely by means of an external light source, makes it possible to avoid electrical or radio frequency disturbances in the enclosure 2. The optical property of one at least of the at least one sensitive element 3 can be observable without the need to be stimulated in a specific way, for example simply by being able to be observed with the naked eye and/or under natural lighting. The optical property of one at least of the at least one sensitive element 3 may require a stimulus provided by emission means, for example by a stimulator element, for example measuring means 7 as described below, in order to be observed. The same measuring means 7 can be used for several devices, for example several reservoirs, reducing the cost relative to the number of reservoirs. Such a device has an intrinsic safety advantage. By the limitation or absence of energy sources necessary for the observation, even outside the enclosure, of the inner sensitive element(s), the invention prevents or reduces the risk of triggering an explosion.

The optical property may depend on one or several parameter(s) of the atmosphere 4 inside the enclosure 1, for example on a single parameter of the atmosphere 4 inside the enclosure 1, for example on the quality of the atmosphere, in which the sensitive element 3 and/or the powder 2 is immersed. The parameter(s) can comprise or be the humidity of the atmosphere 4 inside the enclosure 1, for example the absolute humidity and/or the relative humidity of the atmosphere 4 inside the enclosure 1 and/or the oxygen content of the atmosphere 4 inside the enclosure 1. Alternatively or additionally, the parameter(s) can comprise or be the temperature of the atmosphere 4 inside the enclosure 1, the sensitive element 3 can then comprise one or several thermochromic indicator(s) and/or the pressure of the atmosphere 4 inside the enclosure 1, for example the absolute pressure or the relative pressure of the atmosphere 4 inside the enclosure 1 relative to the pressure of the atmosphere outside the enclosure 1, the sensitive element 3 can then comprise one or several barochromic and/or pH indicator(s) of the atmosphere inside the enclosure 1, the sensitive element 3 can then for example comprise a pH paper. By “relative humidity”, it is meant the ratio between the quantity of water contained in the atmosphere, here the atmosphere inside the enclosure, relative to the maximum quantity that the atmosphere could contain given the temperature and pressure conditions. By “absolute humidity”, it is meant the water vapor content of the atmosphere, here the atmosphere inside the enclosure.

The optical property of the sensitive element(s) 3 can comprise the color, for example a shade of color, the hue, and/or the luminescence, for example fluorescence or the phosphorescence.

The optical property is for example adapted to change for example reversibly, for example when the value of the parameter crosses a threshold, or continuously.

The optical property is for example adapted to change, or for its dynamics of evolution in response to an excitation to change, when the value of the parameter evolves in a continuous range of values. This range of values can be a range of oxygen content values comprised between 0.01% and 3%, or between 0.002% and 21%, or between 0.002% and 10%, or between 0.03% and 100%. This range of values can be a range of oxygen content values comprised between 0.01% and 3% by volume, or between 0.002% and 21% by volume, or between 0.002% and 10% by volume, or between 0.03% and 100% by volume. The optical property is for example adapted to comprise a dynamics of evolution, for example with respect to an excitation, for example optical excitation, external to the device, for example calibrated, for example calibrated in intensity and/or frequency and/or duration, for example provided via the observation means, for example by measuring means 7 as described below, for example luminescence dynamics, for example fluorescence dynamics, for example through the observation means.

The optical property can be an optical property visually observable by the individual, for example a color. Such a device has a cost advantage, because the cost of an observation is zero compared to a technology using sensors and transmitters requiring the contribution of a data collection means, particularly if this technology must be integrated into the device.

The sensitive element 3 or at least one of the sensitive elements 3 can comprise a phosphor sensitive to the parameter, for example to the oxygen content of the atmosphere 4.

The sensitive element 3 or at least one of the sensitive elements 3 can comprise a colored surface whose hue depends on the atmosphere inside the enclosure, for example on the parameter, for example is modified, for example reversibly, as a function of the parameter(s) of the atmosphere 4 inside the enclosure, for example the relative humidity of the atmosphere 4 inside the enclosure 1. The colored surface can comprise one or several colored area(s) changing the hue according to the atmosphere 4 inside the enclosure 1, for example according to the value of the parameter, for example according to the parameter, for example the ambient relative humidity, crosses, for example is above and/or below, a threshold typically of 5%, 10% or 60%.

The sensitive element 3 can be or form a test body.

### Pad

The sensitive element 3 or at least one of the sensitive elements 3 can comprise a pad 3 or 3A. The pad can have the optical, for example dynamic property, for example the luminescence, for example the fluorescence, in reaction to the excitation, for example external optical excitation calibrated, for example in intensity and/or frequency and/or duration, as a function of the value of the parameter, for example of the oxygen content of the atmosphere inside enclosure 1. The pad can be a pad from the PSt3 or PSt6 range from the company PreSens (registered trademark).

The sensitive element 3 can thus comprise a phosphor, for example with a luminescence sensitive to the oxygen content in reaction to a calibrated external optical excitation. Said phosphor can be in the form of a pad, for example a pad to stick against the observation portion 5.

The pad can have a diameter or main dimension comprised between 4 and 20 mm, and/or a thickness comprised between 0.1 and 1 mm.

### Sensitive Element Against the Observation Portion

The sensitive element 3 or at least one of the sensitive elements 3, for example comprising the pad, can be disposed against the observation portion 5, for example against an inner face of the observation portion 5, for example pressed against and/or glued, for example by means of a glue, for example a transparent glue, for example a transparent silicone glue, against the inner face of the observation portion 5, as illustrated in FIG. 4. It is thus possible to minimize the length of the optical path between the sensitive element 3 and the measuring means 7 or the individual, for example between the measuring means 7 as described below, for example arousing and observing the optical response of the sensitive element 3, and the sensitive element. The observation portion 5, for example the window, can have a thickness e≤10 mm, for example at the location where the sensitive element 3, for example the pad 3, is disposed against the observation portion 5, and/or the sensitive element 3, for example the pad, can have a diameter d≥5 mm, and more advantageously d≥10 mm. Such dimensions of the observation portion 5 and/or of the sensitive element 3, for example the pad, make it possible to improve the quality of the optical response of the sensitive element 3.

### Colored Indicator and Colored Surface

The sensitive element 3 or at least one of the sensitive elements 3 can comprise one or several colored indicator(s) 3C, 3D, the hue of each colored indicator depending on the atmosphere inside the enclosure 1, for example changing, for example reversibly, as a function of one of the parameter(s) of the atmosphere 4 inside the enclosure, for example when the value of the parameter crosses a threshold. The parameter can comprise the humidity, for example the relative humidity of the atmosphere 4 inside the enclosure 1, and/or the parameter can be or comprise the oxygen content inside the enclosure. Particularly, the sensitive element 3 or one or several of the sensitive elements 3, for example the colored indicator or one or several of the colored indicators, can comprise or form part of a colored surface whose hue(s) depend(s) on the atmosphere inside the enclosure, for example change(s), for example reversibly, as a function of the parameter of the atmosphere inside the enclosure 1. The colored surface can thus comprise one or several colored area(s), for example each forming one of one or several colored indicator(s), changing the hue depending on whether the parameter, for example the relative humidity, is above or below a threshold, typically of 5%, 10% or 60%. For example, the colored surface can comprise one or several element(s) loaded with cobalt chloride, for example each forming one of one or several colored indicator(s), for example one or several cardboard sheet(s) loaded with cobalt chloride from the company SCS, commercially called “Humidity Indicator Cards”, for example reference 51060HIC125, for example including one or several colored areas taking on a pink or blue hue depending on whether the ambient relative humidity is above or below a threshold, typically of 5%, 10% or 60%.

Within the particular framework of storage by the device or by the system, for example of the preservation, of the metal powder(s) for the additive manufacturing, the sensitive element 3, for example the colored indicator and/or the colored surface, can advantageously have a hue change threshold less than or equal to 10% relative humidity, or more advantageously less than or equal to 5% relative humidity, advantageously greater than or equal to 1% humidity.

The bearing element 12 as described above, against which the sensitive element 3 is disposed, comprising for example the colored surface, can be arranged so that the colored surface is disposed at a distance from the observation portion, the colored surface extending for example at least on one face of the sensitive element 3 opposite to one face of the sensitive element 3 disposed against the bearing element 12. Indeed, for such an element 3, the colored surface, whose optical property is to be observed can thus coincide with a maximized surface of contact and exchange with the atmosphere 4.

The colored indicator(s) can comprise a hydrochromic indicator and/or a thermochromic indicator and/or a barochromic indicator and/or a colored pH indicator.

### Plurality of Sensitive Elements

As described above, and as illustrated in FIG. 13, the device can comprise several sensitive elements 3 disposed inside the enclosure 1.

The at least one sensitive element 3 can comprise a first sensitive element 3B and a second sensitive element 3A. The optical property of the first sensitive element 3B and the optical property of the second sensitive element 3A may be different. The optical property of the first sensitive element 3B may depend on humidity and the optical property of the second sensitive element 3A may depend on the oxygen content of the atmosphere inside the enclosure. The optical property of the first sensitive element 3B can comprise the color and depend on the humidity of the atmosphere inside the enclosure, and the optical property of the second sensitive element 3A can comprise the luminescence, for example the fluorescence, and depend on the oxygen content of the atmosphere inside the enclosure.

The device can thus comprise for example the pad 3A and the colored surface 3B, the colored surface 3B comprising for example the at least two colored indicators 3C and 3D. The pad 3A is for example adapted to provide a luminescent reaction in response to a calibrated external optical excitation, the luminescent reaction depending on the oxygen content in the enclosure 1. The pad 3A is for example from the PSt3 or PSt6 range from the company PreSens (registered trademark). The colored surface 3B can be a support, for example a cardboard support. The hue of the colored surface 3B, for example of the colored indicators 3C and 3D, can vary depending on the corresponding parameter, for example depending on whether the ambient humidity content is above or below the corresponding threshold. The colored surface 3B can be obtained by cutting a sheet, for example from the company SCS commercially called “Humidity Indicator Card”, reference 51060HIC125, for example to preserve the indicator 3C changing color around 5% relative humidity, and the 3D indicator changing color around 10% relative humidity. The pad 3A can be stuck against the inner face of the observation portion 5. The colored surface 3B can be connected to the body by means of the bearing element 12. It is thus possible to read, from outside the enclosure 1 closed by the upper portion 9, the oxygen content inside the enclosure 1, for example by exciting and measuring the luminescence response of the pad 3A using a measuring means 7 as described below, for example of a 7A reader, for example, an O2 P300 reader from the company Nomasense (registered trademark), or a Fibox 4 Traces reader from the company PreSens (registered trademark). The optical path between the reader 7A and the pad 3A can be established by an optical guide 6A, for example measuring means, to the external surface of the observation portion 5. The reading, by the external individual 7B, of the humidity levels indicated by the colored surface 3B is also possible, the individual 7B having a direct line of sight 6B on the colored surface 3B and the colored indicators 3C, 3D.

### Reference Element

As illustrated in FIG. 7, the device can further comprise a reference element 14, for example so that said optical property of the reference element 14 does not depend on the atmosphere 4 inside the enclosure. The optical property of the reference element 14 can for example have a value, for example several values, which the optical property of the sensitive element 3 can take on depending on the atmosphere 4 inside the enclosure, the reference element 14 being for example disposed inside the enclosure. It is thus possible to assess the optical property or its variation, for example the color or the shade of color, of the sensitive element 3 relative to the optical property, for example the color or shade of color, of the reference element 14. The reference 14 can be disposed out of the enclosure 1 or inside the enclosure 1.

The reference element 14 can have one or several reference color(s), for example one or several reference hue(s). The reference element 14 can thus have one or several colored flats, a color chart, a gradient, a camaieu, for example painted or printed. For a reference element 14 associated with a sensitive element 3 forming a humidity indicator, the color chart can give visual references of several colors so as to guide an observer in the quantification of what is observed, and therefore for example of the observed humidity, the colors of the color chart can comprise a marked pink, a light pink, a gray, a light blue and/or a dark blue.

The reference element 14 can comprise a duplicate of the sensitive element 3, made insensitive to the qualities of the atmosphere 4 inside the enclosure, for example by application of a protective varnish. The reference element 14 can be disposed inside the enclosure 1, for example so that the observation means make it possible to observe the optical property of the reference element 14 from outside the enclosure 1, for example concomitantly with the sensitive element. The reference element 14 can thus be disposed so as to appear in the visual field of the individual and/or of the measuring means 7 as described below, for example concomitantly with the sensitive element 3.

The reference element 14 can be disposed inside the enclosure 1, for example so that the same optical property distortions, for example of colors, due to the observation portion 5, and/or the same parasitic optical effects, for example shadows and/or reflections, apply to both the reference element 14 and to the sensitive element 3 during their observation from outside the enclosure 1.

The sensitive element 3 can comprise the reference element 4, for example so that the reference element 4 is disposed in the same way as the sensitive element, as described above.

Alternatively, the reference element 4 can be distinct from the sensitive element 3.

Alternatively or additionally, in a manner similar to what has been described above concerning the sensitive element 3, the reference element 14 can be connected, for example in a secured manner, to the body 8 and/or to the upper portion 9, for example by means of one or several connecting part(s). The device can comprise a dedicated bearing element, for example a dedicated bearing part, of one of the reference elements 14, against which the reference element is disposed, so that the reference element 14 is disposed at a distance from the observation portion 5. The reference element 14 can be disposed facing the observation portion 5 or a reflection element 16 as described above. The description of the bearing element 12 of the sensitive element 3 applies to the bearing element of the reference element 14. The device can comprise means for holding the reference element 4 on the dedicated bearing element. The description of the means for holding the sensitive element 3 applies to the means for holding the reference element 4. Alternatively or additionally, the reference element can comprise a pad. The description of the pad of the sensitive element 3 applies to the pad of the reference element 4. Alternatively or additionally, the reference element, for example being or comprising the pad, or the pad, can be disposed against the observation portion 5, for example against an inner face of the observation portion 5, for example pressed against and/or glued, for example by means of a glue, for example a transparent glue, for example a transparent silicone glue, against the inner face of the observation portion 5. It is thus possible to minimize the length of the optical path between the reference element and the measuring means 7 or the individual, for example between the measuring means 7 as described below, for example arousing and observing the optical response of the reference element, and the reference element. The observation portion 5, for example the window, can have a thickness e≤10 mm, for example at the location where the reference element 4, for example the pad, is disposed against the observation portion 5, and/or the reference element 4, for example the pad, can have a diameter d≥5 mm, and more advantageously d≥10 mm. Such dimensions of the observation portion 5 and/or of the reference element 4, for example the pad, make it possible to improve the quality of the optical response of the reference element 4, for example of the pad.

### Filtration Means

The device can further comprise means for filtering particles suspended in the atmosphere inside the enclosure 1, comprising for example one or several filter(s) 23, for example arranged to limit or avoid the deposition of the particles in suspension on the sensitive element 3 and/or on the observation portion 5, for example on the inner face of the observation portion 5, and/or on the reflection element 16 and/or on the second observation portion 5′, for example on the second inner face of the second observation portion 5, and/or on the second reflection element. It is thus possible to protect from the deposition of particles or from excessive deposition of particles, particularly of powder, suspended in the atmosphere 4, all or part of the sensitive element 13, and/or of the inner face of the observation portion 5, and/or of the reflection element(s) 16, particularly disposed inside the enclosure 1, and/or of the second inner face of the second observation portion 5′, and/or of the second reflection element(s) 16, particularly disposed inside the enclosure 1, by dust isolation by the filter(s) 23.

The filter(s) can comprise a filter wall, for example separating the space inside the enclosure between a first storage portion where the powder 2 is stored, and a second portion of filtered atmosphere, at level of which the sensitive element 3 and/or the observation portion 5, for example the inner face of the observation portion 5, and/or the reflection element 16 and/or the second observation portion 5′, for example the second inner face of the second observation portion 5, and/or the second reflection element, is/are disposed.

### Measuring Means

The system and/or the device can comprise measuring means 7 disposed outside the enclosure 1. The measuring means 7 can be configured to measure the optical property of the sensitive element 3 and/or of the reference element 14, via the observation portion 5. The measuring means 7 can be or comprise a measuring element.

The measuring means 7 can comprise emission means, for example means for emitting the excitation, for example optical excitation, external to the device, for example calibrated, for example calibrated in intensity and/or frequency and/or duration, for example provided to the sensitive element 3 and/or to the reference element 14, for example via the observation means 5, for example so as to cause a reaction of the sensitive element 3 and/or of the reference element 14.

The measuring means 7 can comprise receiving means, for example means for optically receiving radiation derived from the sensitive element 3 and/or from the reference element 14, for example for receiving the excitation, for example via the observation means 5, for example so as to obtain data relating to the optical property of the sensitive element 3 and/or of the reference element 14. The measuring means 7 can comprise an electronic camera, or an optical probe comprising detection means such as a photodiode, possibly coupled to emission means, for example an illuminator, for example forming the or forming part of the emission means, coupled to a photodetector, for example forming the or forming part of the receiving means, for example to estimate a color or luminescence of the sensitive element 3 in the case of an evaluation of humidity or oxygen content. The measuring means 7 can comprise, for the luminescence, a reader 7A, for example, an O2 P300 reader from the company Nomasense (registered trademark), and/or a Fibox 4 Traces reader from the company PreSens (registered trademark).

The measuring means 7 can comprise an optical guide 6A, for example extending between the emission means and/or the receiving means, and the outer surface of the observation portion 5, for example extending from the emission means and/or receiving means, to the outer surface of the observation portion 5.

The same measuring means 7 can be used for several devices, reducing the cost relative to the number of reservoirs.

### Concealing Means and Optical Filtering Means

The device can comprise means 17 and/or 18 for concealing the observation portion 5 and/or the second observation portion 5′. The concealing means can comprise a concealing element. The concealing means can be adapted to selectively limit the passage of light coming from outside the enclosure 1 through the observation portion 5 and/or the second observation portion 5′. It is thus possible to avoid or limit the light inside the enclosure outside the observation phases of the sensitive element 3.

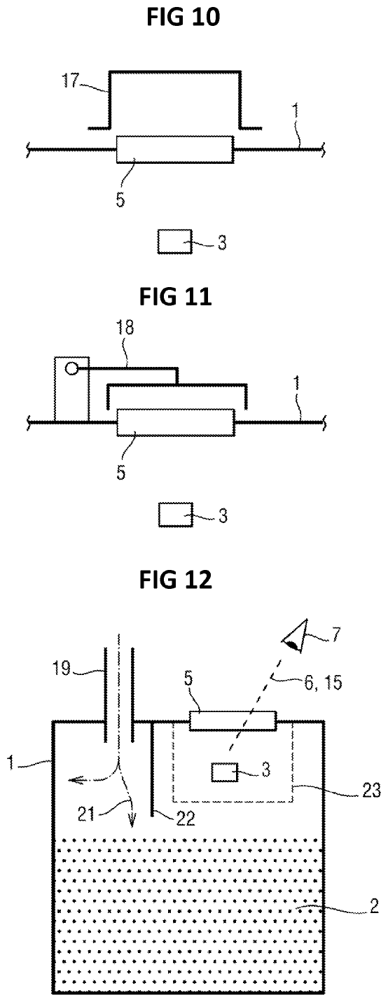

The concealing means can comprise a removable cap 17, for example adjustable on the observation portion 5, for example on the outer face of the observation portion 5, as illustrated in FIG. 10. Alternatively or additionally, the concealing means can comprise a tilting flap 18, for example secured to the enclosure 1, as illustrated in FIG. 11, adjustable on the observation portion 5, for example on the outer face of the observation portion 5.

The concealing means are particularly useful in the case where the sensitive element 3 comprises a phosphor sensitive to the oxygen content of the atmosphere 4. Indeed, such a phosphor can for example be degraded by prolonged exposure to light and particularly to ultraviolet rays.

Similarly, the concealing means can comprise a second removable cap, for example adjustable on the second observation portion 5′, for example on the second outer face of the second observation portion 5′. Alternatively or additionally, the concealing means can comprise a second tilting flap, for example secured to the enclosure 1, adjustable on the second observation portion 5′, for example on the second outer face of the second observation portion 5′.

The same removable cap 17 can for example be adjustable on the observation portion 5 and the second observation portion 5′, for example on the outer face of the observation portion 5 and the second outer face of the second observation portion 5′. Alternatively or additionally, the same tilting flap 18, for example secured to the enclosure 1, can be adjustable on the observation portion 5, for example on the outer face of the observation portion 5 and on the second observation portion 5′, for example on the second outer face of the second observation portion 5′.

Alternatively or additionally, the observation portion 5 can comprise means for optically filtering the light coming from outside the enclosure 1 through the observation portion 5 and/or the second observation portion 5′. The optical filtering means can comprise a filtering coating layer, for example filtering the ultraviolet rays, for example disposed at the level of the outer face and/or of the second outer face. Alternatively or additionally, the optical filtering means can comprise or be a material constituting the observation portion having this property, so that the volume of the observation portion 5 and/or of the second observation portion 5′, ensures the or participates in the filtering, for example in the filtering of the ultraviolet rays.

### Powder Inlet and/or Outlet Path(s)

As illustrated in FIG. 13, the device can comprise one or several powder inlet and/or outlet path(s), for example at least one powder inlet path and/or one powder outlet path.

The device, for example the enclosure 1, for example the body 8 or the upper portion 9, for example the cover, can thus comprise one or several powder inlet path(s). The powder inlet path can comprise a powder supply duct 26, the supply duct 26 being able for example to pass through the upper portion 9, for example the cover. The powder inlet path can comprise closing means, for example a closing valve 27, for example a butterfly valve, for example powder and/or gas-tight closing valve, for example adapted to close the supply duct 26.

The device, for example the enclosure 1, for example the body 8 and/or the lower portion 802, can thus comprise one or several powder outlet path(s). The powder outlet path can comprise a powder discharge duct 28 out of the enclosure 1. The powder outlet path can comprise closing means, for example a closing valve 29, for example a butterfly valve, for example a powder and/or gas-tight closing valve, for example adapted to close the discharge duct 28.

### Gas Injection and/or Withdrawal Path(s)

As illustrated in FIGS. 12 and 13, the device can comprise one or several path(s) for injecting and/or withdrawing gas, for example inerting gas, for example at least one gas injection path and/or one gas withdrawal path.

The device, for example the enclosure 1, for example the body 8 or the upper portion 9, for example the cover, can thus comprise one or several gas injection path(s) 19. The injection path 19 can comprise an injection tapping 30. The injection tapping 30 can comprise closing means, for example a closing valve 32, for example a valve, for example a ball valve, for example a powder and/or gas-tight closing valve, for example adapted to close the injection tapping 30. The injection tapping 30 can comprise coupling means 34, for example means for quick coupling for example to a gas source.

The device can comprise means for protecting the sensitive element 3 with respect to gas injected via the injection path 19, for example to avoid or limit direct sweeping of the sensitive element 13 by an incoming stream 21 of gas injected via the injection path 19. Indeed, in the case of gas injection, a sensitive element 13 directly swept by the stream 21 of gas entering the enclosure 1 would risk having its optical properties strongly dependent on the quality of the incoming gas at the expense of the influence of that of the atmosphere 4 in which the incoming stream 21 is gradually diluted, compared to a stable state where the gas is not in movement. The means for protecting the sensitive element with respect to injected gas can be or comprise one or several protection(s), for example one or several wall(s), for example one or several facing(s) and/or baffle(s) 22. The means for protecting the sensitive element 3, for example the facing(s) and/or baffle(s) 22, can be arranged so as to limit or avoid a direct impact of the incoming stream 21 of gas injected onto the stored powder 2, for example on the powder bed formed by the stored powder 2, and therefore limit the projection and suspension of powder 2 capable of opacifying the inner face of the observation element 5 and/or covering one face of the sensitive element 3, and/or constituting a cloud between the observation element 5 and the sensitive element 3 that would hinder the observation of the sensitive element 3 and/or of the stored powder 2. The device, for example the enclosure 1, for example the body 8 and/or the upper portion 9, can thus comprise one or several gas withdrawal path(s). The withdrawal path can comprise a withdrawal tapping 31. The withdrawal tapping 31 can comprise closing means, for example a closing valve 33, for example a valve, for example a ball valve, for example a powder and/or gas-tight closing valve, for example adapted to close the withdrawal tapping 31. The withdrawal tapping 31 can comprise coupling means 35, for example means for quick coupling for example to a gas outlet.

### Pressure Measuring Means

The device, for example the enclosure 1, for example the body 8 or the upper portion 9, for example the cover, can comprise or present pressure measuring means 24A and 25. The pressure measuring means are for example adapted to measure a relative pressure between the pressure inside the enclosure 1 and the ambient pressure or pressure outside the enclosure, for example a relative pressure located between 0.05 and 1 bar, for example between 100 mbar and 300 mbar.

The device, for example the enclosure 1, for example the body 8 or the upper portion 9, for example the cover 9, can thus comprise or present pressure measuring means 24A adapted to provide a direct reading of the pressure inside the enclosure 1, for example a pressure gauge 24A.

Alternatively or additionally, the device, for example the enclosure 1, for example the body 8 or the upper portion 9, for example the cover, can thus comprise or present digital pressure measuring means, for example a digital pressure sensor 25, for example powered by a battery cell. The digital pressure measuring means, for example the digital pressure sensor 25, can comprise means for transmitting, for example wirelessly transmitting, for example by radio waves, for example following a Bluetooth protocol, for example Bluetooth Low Energy or following a LoRa protocol, pressure measurements made by the digital pressure measuring means, for example by the digital pressure sensor. The device, for example the enclosure 1, for example the body 8 or the upper portion 9, for example the cover 9 can further comprise or present a flange 24B accommodating the digital pressure measuring means, for example the digital pressure sensor 25. The digital pressure sensor 25 is for example a U5600 pressure sensor from the company TE Connectivity measuring relative pressures from 0 to 350 mbar, and using Bluetooth Low Energy technology for radio communications.

### Identification Means

The device can comprise means for identifying and/or tracking 36 the device and/or the enclosure 1 and/or the content of the enclosure, for example the powder contained in the enclosure. The enclosure 1, for example the body 8 and/or the upper portion 9, for example the cover, can present the identification and/or tracking means 36. The identification and/or tracking means 36 can be or comprise a marker, the marker being for example a chip, for example an RFID (Radio Frequency IDentification) marker, for example an RFID NFC (Near Field Communication) marker 36.

### Powder

The powder of each device may be identical. Alternatively, the powder 2 may differ from one device to another.

The powder 2 can be a homogeneous or heterogeneous powder. The powder 2 can be or comprise a mixture of powders of different composition and/or properties, for example a mixture of a new powder and of a recycled powder.

The powder 2 can be an additive manufacturing powder.

The invention finds particular utility in the field of metal additive manufacturing, particularly with respect to or within the framework of a selective laser melting (laser beam melting) method, for example selective laser melting called “powder bed” melting, in which significant quantities of powder are involved.

The powder 2 can be a metal powder, for example an oxidizable metal powder. The powder 2 can comprise nickel and/or titanium and/or aluminum and/or inconel (registered trademark) and/or copper and/or iron. The powder 2 can be a nickel or aluminum or iron or titanium or copper based alloy powder. The powder 2 can be an Inconel powder (registered trademark), for example Inconel® 625 or Inconel® 718, or AlSi7Mg0.6, or TA6V, or 316L, or 42CrMo4 powder (also known under the reference AISI4140), or Maraging 300 powder. Alternatively, the powder can be plastic or ceramic.

The powder can be micrometer grain, particularly micrometer grain metal powder. The grain size distribution of the powder can be of a size systematically less than 200 μm, and for example typically mainly distributed between 5 and 60 μm, for example for the selective laser melting method.

The powder 2 may have a morphology of particles that composes it, corresponding to a substantially spherical shape. It is thus possible to maximize the spreadability capacity.

The powder 2 can present a reactive nature and/or an ATEX risk, in particular related to a large specific surface, for example of the order of 0.01 to 10 m² per gram.

The powder 2 can have limited flowability from the sorption of a small quantity of water, for example sticking phenomena intolerable for the production from a water sorption equivalent to 0.05% to 0.5% of the mass of the grains.

The powder 2 can be reactive, for example capable of self-ignition, for example in contact with an oxidant such as oxygen, for example gaseous oxygen, for example atmospheric oxygen. Alternatively or additionally, the powder may have been passivated, for example by the formation of a surface oxide layer, for example by exposure, for example voluntary or involuntary exposure, to an oxidant.

Such a metal powder 2 can be a powder adapted to serve as a raw material in additive manufacturing.

Such a powder 2 must be stored in an inert, dry and oxygen-depleted atmosphere to limit the degradation of the powder and reduce the ATEX risk. For some materials, for example when the powder is an aluminum powder, the composition and maintenance of the inert atmosphere also makes it possible to avoid their contamination by other gaseous species such as hydrogen or nitrogen.

The device allows the evaluation of the oxygen content and of the relative humidity of the atmosphere present inside the enclosure 1. Particularly for the additive manufacturing, with applications requiring a relative humidity of less than 10% or 5%, and an oxygen content below a threshold, the threshold being for example comprised between 0.01% and 3%, for example an oxygen content of less than 3% or an oxygen content of less than 0.01%, but also for other powder metallurgy methods.

The powder 2 can be or comprise recycled powder, for example having already been used in an additive manufacturing process. Such a powder can comprise nanometer particles, for example derived from vaporization phenomena at the point of impact of the energy beam allowing the melting of the powders, and considered as unwanted, for example because they are more loaded with contaminating elements, for example oxygen and hydrogen. Furthermore, nanometer particles can themselves introduce a health risk for operators during the manipulation of the powders.

The recycled powder can comprise aggregates of particles of micrometer sizes. The non-spherical aggregates modify the particle size distribution and deteriorate the physicochemical properties of the powder, such as flowability. Furthermore, the presence of this type of particles causes melting quality defects during the additive manufacturing methods by reducing the homogeneity of the metallurgical properties of the implemented material.

The powder can still pose a health risk, the powder being able for example to have a carcinogenic or carcinogen nature, for example when the powder comprises nickel or titanium.

The device can preserve some properties of the powder, for example properties related to the use for which the powder is intended, particularly if the powder is a powder intended to be mixed or resulting from a mixture. The device preserves by example the state of segregation and/or the state of abrasion of the stored powder 2. For example, the device does not generate segregation by density, material or morpho-granulometry of the powder it contains, and/or abrasion of the powder. The abrasion leads to a loss of sphericity, and/or to a modification of particle size, and/or to the creation of dust.

### Dimensions

The device can be compact. For example, the device, for example the enclosure 1, the sensitive element 3 and the observation means 5 combined, can have dimensions smaller than the dimensions of a parallelepiped with dimensions 55×45×69 cm, for example can fit into such a parallelepiped. The measuring means 7 can have dimensions smaller than the dimensions of a parallelepiped with dimensions 10×12×20 cm, for example can fit into such a parallelepiped.

### Exemplary embodiments

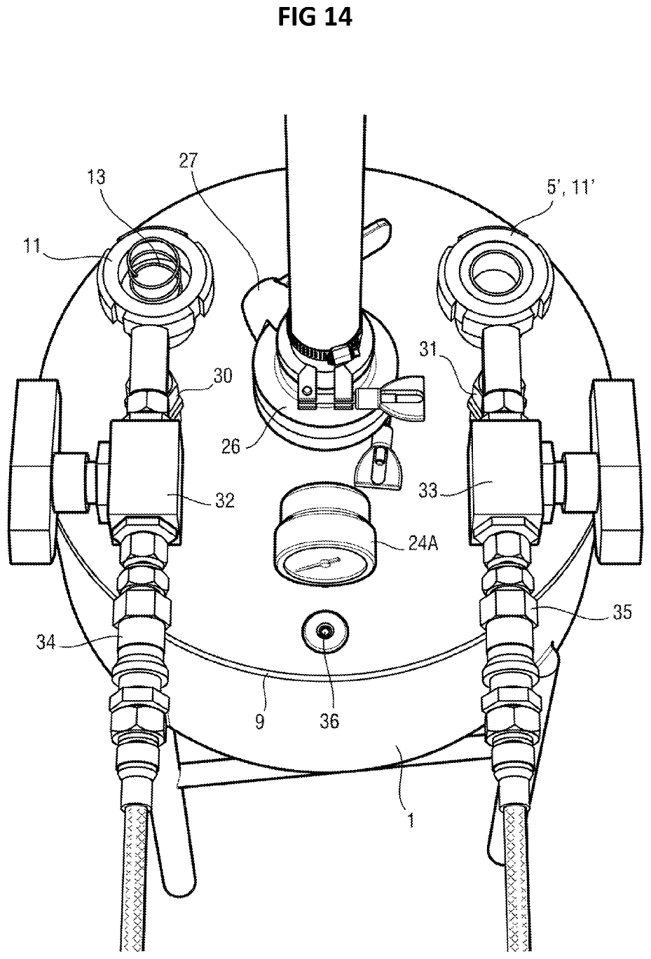

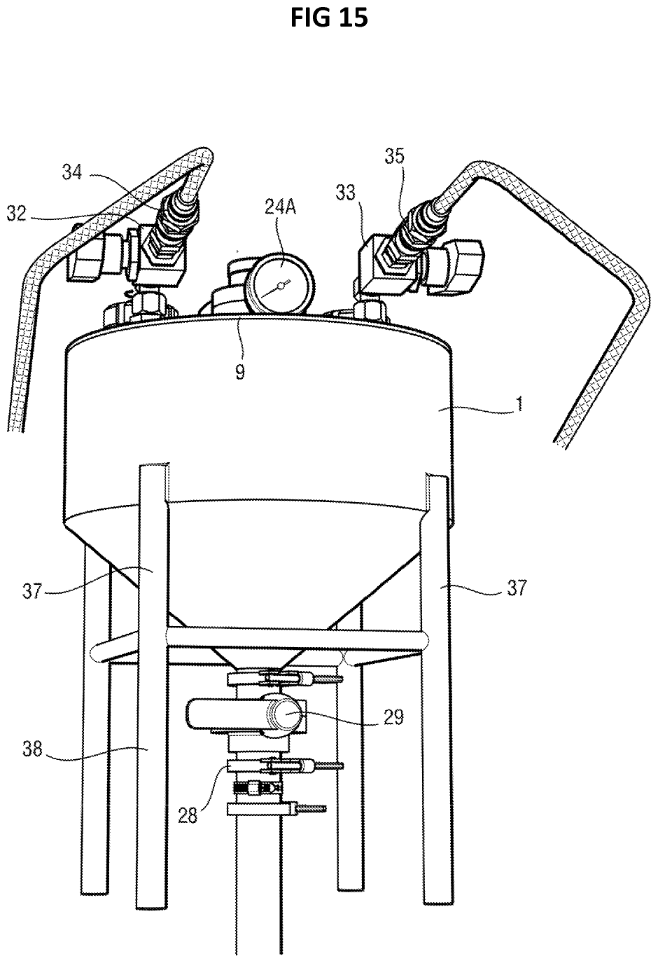

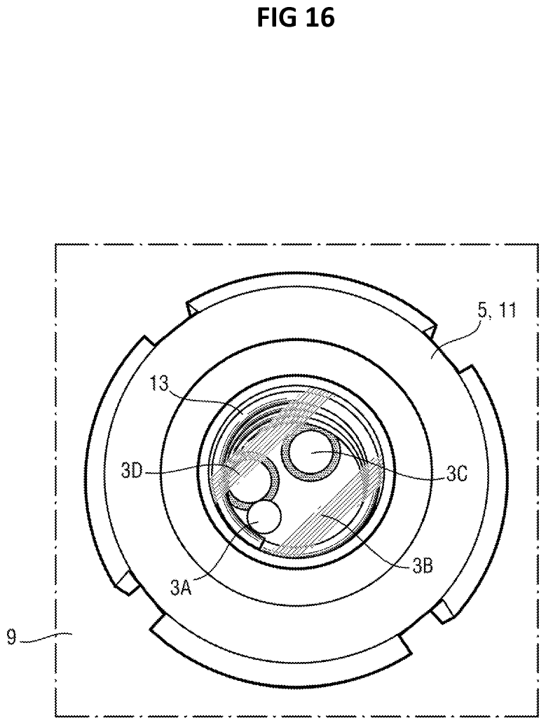

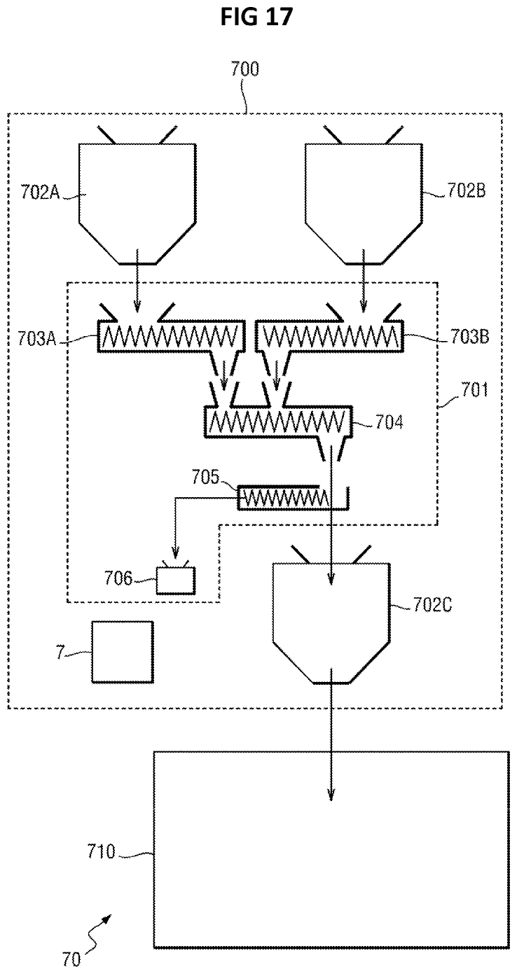

FIGS. 14, 15 and 16 reproduce photographs of one example of the device corresponding to that of FIG. 13. FIG. 14 is a top view of the enclosure 1, in its use as a receptacle for powders at the outlet of the dosing and mixing sub-assembly 701. FIG. 15 is a side view of the enclosure 1 slightly from above, in a use as a powder dispenser, for example for the powder dosing and mixing sub-assembly 701. FIG. 16 is an external top view along the axis of the window 5.

### Method

### General Description of the Method

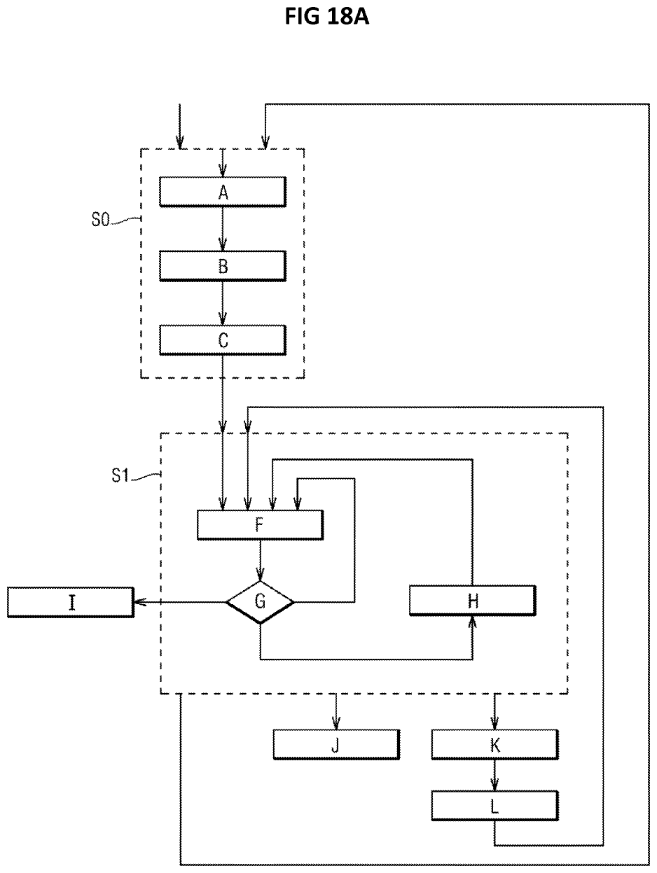

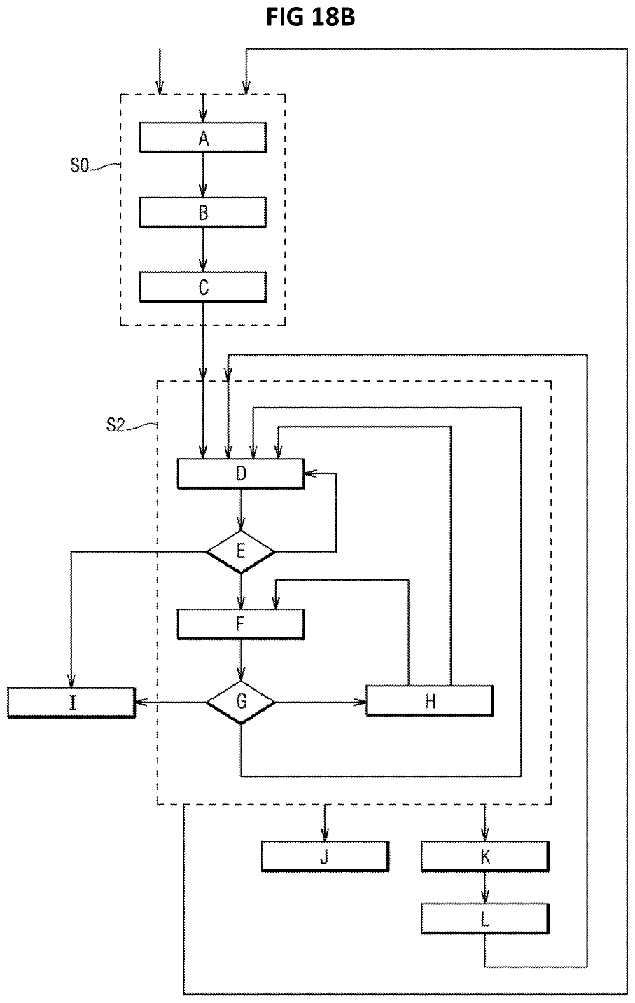

With reference to FIGS. 18A and 18B, a method for storing a powder inside the enclosure 1 of the device or system is described.

The method can comprise a step S0 of storing and/or loading a powder.

During step S0, a prior modification A of the atmosphere can occur, for example prior to powder loading. The modification of the atmosphere can take place during pre-filling of the enclosure with an inert gas. The modification of the atmosphere can still take place during a storage prior to the powder loading. The modification can still take place when conditions have changed inside the enclosure, for example when the humidity or the oxygen content or the pressure changes. The prior modification A can be a modification causing a modification of the optical property of the observable sensitive element 3. step S0 can comprise, for example subsequently to the modification A, a step B of loading powder inside the enclosure 1, for example by means of the powder inlet path. Step B can comprise the loading of powder, the powder being for example derived from an inerted environment so that its transfer takes place under inerting continuity, the powder being for example derived from the dosing sub-assembly 701. Alternatively, step B can comprise the discharge into the empty enclosure, for example into the device 702A and/or 702B, of a powder derived from a primary storage in an ambient atmosphere. During step S0, a modification C of the atmosphere inside the enclosure may occur subsequently to the loading B, for example as a result of the loading B. The modification C can be a modification causing a modification of the optical property of the observable sensitive element 3. The modification C can take place during the inerting gas supply of a powder stored in the enclosure, the powder having for example been discharged after primary storage in an ambient atmosphere, for example in the device 702A and/or 702B. Alternatively, step C can be a corrective modification of the atmosphere, for example associated with a predetermined command, for example to eliminate contaminants possibly brought back by the powder or by a manipulation error during the loading B.

The method can comprise a series S1 of storage maintaining steps. The series S1 can form a cycle, the steps of the cycle can be repeated, for example periodically or non-periodically, for example any number of times.

The series S1 can comprise a step of measuring the optical property(ies) associated with the sensitive element(s) 3, for example comprising the observation of the optical property of the element sensitive 3 from outside the enclosure 1 by the observation means, for example via the at least partially transparent observation portion 5.

The series S1 can comprise a step G of evaluating the atmosphere, for example of evaluating the parameter(s), for example based on the optical property(ies) measured and/or observed in the measuring step F and/or decision step, for example of decision based on the evaluated parameter(s) and/or on the optical property(ies) of the sensitive element 3, measured and/or observed in the measuring step F.

The decision can comprise an absence of action, for example in the absence of identification of a modification in the atmosphere inside the enclosure requiring an action, the absence of action can for example comprise a resumption of the cycle S1, for example a repetition of the measuring step F, for example until identification of a modification in the atmosphere inside the enclosure.

The decision may result in the implementation of a corrective atmosphere modification step H, based on the optical property of the sensitive element 3, for example in the event of identification of a modification of the atmosphere inside the correctable enclosure, then for example a resumption of the cycle S1, for example comprising a repetition of the measuring step F, for example until identification of another modification of the atmosphere inside the enclosure 1.

The corrective modification H can comprise an injection of gas, for example of inert gas, for example comprising or consisting of argon and/or an inert gas adapted according to the nature of the powder.

The corrective modification H can comprise an exhaust of a fraction of the gas contained in the enclosure 1. The corrective modification H can comprise a simultaneous combination of gas injection and exhaust, thus carrying out a sweeping. It is thus possible to vary the pressure and/or the oxygen content, and/or the humidity of the atmosphere inside the enclosure 1. The corrective modification H can be implemented automatically or manually.

In the case of automated implementation, the modification can comprise an automated adjustment of gas injection and/or gas exhaust flow rate, the automated adjustment can comprise a servo-control and/or an automatic start and stop. The automated adjustment can be carried out in real time by means of the measurement of the sensitive element 3 by the measuring means 7, and possibly additionally via the pressure measuring means 24A and 25.

In the event of manual implementation, the modification can comprise a manual adjustment of the gas injection and/or gas exhaust flow rate, the manual adjustment being able to be carried out by means of one or several valve(s), the valve(s) being or comprising one or several valve(s) of the device and/or one or several valve(s) external to the device. The manual adjustment can be carried out by an operator who adapts the adjustment in real time by means of the sensitive element 3, and possibly additionally via the pressure measuring means 24A and 25.

The decision can result in the implementation of an output step I of the cycle S1, for example in the event of identification of a modification in the atmosphere inside the uncorrectable enclosure, step I can comprise the extraction of all of the powder. The powder extracted on this occasion is for example considered unusable.

The method can comprise, for example during cycle S1, a step J of extracting all of the powder, the powder being for example considered usable. The extraction step J can interrupt the cycle S1.

The method can comprise, for example during cycle S1, a step K of extracting a portion of the powder, the powder being for example considered usable. The portion extraction step K can interrupt the cycle S1 and/or be followed by a corrective atmosphere modification step L. The corrective modification step L can be followed by a resumption of the cycle S1, for example by a repetition of the measuring step F. The method can comprise, for example during cycle S1, a new powder loading step S0. The new powder loading step S0 can interrupt the cycle S1. The new step S0 can be followed by a resumption of the cycle S1, for example by a repetition of the measuring step F.

### Method not Using Pressure Information

As illustrated in FIG. 18A, the method may not use pressure information. The method can then be implemented as described above, without pressure information being measured or without any pressure information being used.

### Method Using Pressure Information

Alternatively, as illustrated in FIG. 18B, the method can use pressure information.

Step S0 is implemented as described above.

The series S1 of storage maintaining steps differs from the one described above. The series S1 can form a cycle, the steps of the cycle can be repeated, for example periodically or non-periodically, for example any number of times.

The series S1 can comprise, prior to the step of measuring the optical property(ies) F, a step D of measuring the pressure of the atmosphere inside the enclosure 1.

The series S1 can comprise, prior to the step of measuring the optical property(s) F and subsequently to the pressure measuring step D, a step F of evaluating the atmosphere, for example of evaluating the pressure measured in the pressure measuring step D and/or a decision step, for example decision based on the pressure evaluated and/or the pressure measured in the pressure measuring step D.

The decision of step E can comprise an absence of action, for example in the absence of identification of a modification in the atmosphere inside the enclosure requiring an action, the absence of action can for example comprise a resumption of the cycle S1, for example an implementation of the measuring step F.

The decision of step E can lead to the implementation of the output step I of the cycle S1, for example in the event of identification of a dangerous pressure modification for maintaining the quality of the powder, the step I can comprise the extraction of all of the powder. The dangerous pressure modification can comprise the case where the pressure drops below a certain threshold, for example 100 mbar. Indeed, a pressure below a certain value may be a sign of leakage from the enclosure 1, and therefore a sign that the enclosure 1 no longer protects the powder 2 from the entry of external contaminants. Alternatively, the identification of the dangerous pressure modification can trigger the implementation of step F as described below. It is thus possible to check whether the atmosphere has actually been contaminated, for example by oxygen or humidity and in what proportions, and to decide, in step G as described below, whether a correction of the atmosphere can stop the degradation of the powder before it is unfit for the intended use, in which case a corrective atmosphere modification step H as described below is implemented to remove the unwanted constituents, or whether the powder has reached a state of degradation such that it is unfit for the intended use, in which case an output step I of the cycle S1 is implemented.

The decision step E can lead to the implementation of the step of measuring the optical property(ies) F associated with the sensitive element(s) 3, comprising for example the observation of the optical property of the sensitive element 3 from outside the enclosure 1 by the observation means, for example via the at least partially transparent observation portion 5.

The series S1 can comprise the step G of evaluating the atmosphere, for example of evaluating the parameter(s), for example as a function of the optical property(s) measured and/or observed at the measuring step F and/or a decision step, for example decision based on the evaluated parameter(s) and/or on the optical property(ies) measured and/or observed in the measuring step F.

The decision in step G can comprise an absence of action, for example in the absence of identification of a modification in the atmosphere inside the enclosure requiring an action, the absence of action can for example comprise a resumption of the cycle S1, for example comprising a repetition of the pressure measuring step D.

The decision of step G can lead to the implementation of a corrective atmosphere modification step H, based on the optical property of the sensitive element 3, for example in the event of identification of a modification of the atmosphere inside the correctable enclosure, then for example a resumption of the cycle S1, for example a repetition of the pressure measuring step D or of the measuring step F, for example until identification of another modification of the atmosphere inside the enclosure 1.

The repetition of the pressure measuring step D can for example be triggered in the event of a suspected powder preservation problem by the pressure measurement D in the first cycle, confirmed by the detection of contaminants in step F in the first cycle.

The repetition of step F can for example be triggered if the pressure measurement D gave an acceptable value but if step F in the first cycle revealed the presence of contaminants. Such a situation occurs, for example, in the case of a well sealed reservoir containing a very humid powder which gradually releases part of its humidity into the internal atmosphere.

The corrective modification H can comprise an injection of gas, for example of inert gas, for example comprising or consisting of argon and/or an inert gas adapted to the nature of the powder. The corrective modification H can comprise an exhaust of a fraction of the gas contained in the enclosure 1. The corrective modification H can comprise a simultaneous combination of gas injection and exhaust, thus carrying out a sweeping. It is thus possible to vary the pressure and/or the oxygen content, and/or the humidity of the atmosphere inside the enclosure 1. The corrective modification H can be implemented automatically or manually, as described above.

The decision of step G can lead to the implementation of an output step I of the cycle S1, for example in the event of identification of a modification in the atmosphere inside the uncorrectable enclosure, step I can comprise the extraction of all of the powder. The powder extracted on this occasion is, for example, considered unusable.

The method can comprise, for example during the cycle S1, the extraction step J of all of the powder as described above.

The method can comprise, for example during the cycle S1, the step K of extracting part of the powder as described above. The portion extraction step K can interrupt the cycle S1 and/or be followed by the corrective atmosphere modifying step L. The corrective modification step L can be followed by a resumption of the cycle S1, for example by a repetition of the pressure measuring step D.

The method can comprise, for example during cycle S1, the new powder loading step S0. The new powder loading step S0 can interrupt the cycle S1. The new step S0 can be followed by a resumption of the cycle S1, for example by a repetition of the pressure measuring step D.

1. A powder storage device comprising an enclosure adapted to contain a powder and an atmosphere, the device comprising at least one sensitive element disposed inside the enclosure, so that at least one optical property of the sensitive element depends on the atmosphere inside the enclosure, the device comprising observation means comprising at least one at least partially transparent observation portion, the observation means making it possible to observe the optical property of the sensitive element from outside the enclosure.

2. The device according to claim 1, wherein the optical property of one at least of the at least one sensitive element comprises the color and/or the luminescence.

3. The device according to claim 1, wherein the optical property of one at least of the at least one sensitive element depends on humidity and/or on oxygen content of the atmosphere inside the enclosure.

4. The device according to claim 3, wherein the optical property of one at least of the at least one sensitive element depends on humidity of the atmosphere inside the enclosure, and the optical property of at least another of the at least one sensitive element depends on the oxygen content of the atmosphere inside the enclosure.

5. The device according to claim 1, wherein the observation means further comprise at least one at least partially reflective reflection element.

6. The device according to claim 1, comprising a bearing element of the sensitive element, against which the sensitive element is disposed, so that the sensitive element is disposed at a distance from the observation portion.

7. The device according to claim 6, further comprising an elastic element arranged to hold one at least of the at least one sensitive element on the bearing element.

8. The device according to claim 1, wherein one at least of the at least one sensitive element is disposed against the observation portion.

9. The device according to claim 1, further comprising a reference element, so that an optical property of the reference element does not depend on the atmosphere inside the enclosure, the optical property of the reference element having a value that the optical property of the sensitive element can take based on the atmosphere inside the enclosure.

10. The device according to claim 1, further comprising means for filtering particles suspended in the atmosphere inside the enclosure, arranged to limit or avoid deposition of the particles in suspension on the sensitive element and/or on the observation portion and/or on an at least partially reflective reflection element of the observation means.

11. The device according to claim 1, wherein the powder storage device is a storage device intended for additive manufacturing, the device being adapted to preserve the stored powder with a view to using the stored powder in an additive manufacturing method.

12. The device according to claim 1, wherein the enclosure contains powder, the powder being a metal powder.

13. A system comprising a device according to claim 1, and measuring means disposed outside the enclosure, the measuring means being configured to measure the optical property of the sensitive element via the observation portion.

14. A method for storing a powder inside the enclosure of a device according to claim 1, the method comprising a step of loading and/or extracting the powder inside the enclosure.

15. A storage method according to claim 14, the method further comprising a step of correctively modifying the atmosphere inside the enclosure, depending on the optical property of the sensitive element.

16. A method for storing a powder inside the enclosure of a system according to claim 13, the method comprising a step of lading and/or extracting the powder inside the enclosure.

17. A storage method according to claim 16, the method further comprising a step of correctively modifying the atmosphere inside the enclosure, depending on the optical property of the sensitive element.
